(19) United States
(12) Patent Application Publication
(10) Pub. No.: US 2021/0066881 A1
(43) Pub. Date: Mar. 4, 2021

(54) Laser Oscillator System Having Optical Element For Injection Seeding and Method of Manufacture

(71) Applicant: NEWPORT CORPORATION, Irvine, CA (US)

(72) Inventor: Kay Mittler, Falkenser (DE)

(73) Assignee: NEWPORT CORPORATION, Irvine, CA (US)

(21) Appl. No.: 16/957,812

(22) PCT Filed: Dec. 20, 2018
(86) PCT No.: PCT/US2018/066807

§ 371 Date: Jun. 25, 2020

Related U.S. Application Data
(60) Provisional application No. 62/610,863, filed on Dec. 27, 2017.

(51) Int. Cl. H01S 3/10; H01S 3/08; H01S 3/081; H01S 3/083; H01S 3/11

(52) U.S. Cl. CPC H01S 3/10092; H01S 3/08068; H01S 3/11; H01S 3/0815; H01S 3/083; H01S 3/0805

(57) ABSTRACT

The present application is directed to various architectures of a laser oscillator which include an optical element, reflective, refractive, or diffractive injection device for injection seeding and/or locking a laser oscillator.

### CROSS-REFERENCE TO RELATED APPLICATIONS

The present application claims priority to U.S. Provisional Patent Appl. Ser. No. 62/610,863, filed on Dec. 27, 2017, and entitled “Laser Oscillator System Having Optical Element For Injection Seeding and Method of Manufacture,” the entire contents of which are incorporated by reference herein.

### BACKGROUND

Presently, laser oscillators and similar devices are used in a wide variety of applications. For example, systems incorporating laser oscillators are commonly used in semiconductor fabrication applications, material processing, and the like. FIG. 1 shows an exemplary prior art seeded linear laser oscillator. As shown, the laser oscillator 1 includes a partially reflective mirror 3 (hereinafter HRM with a reflectivity of R<1), an output coupler 5, and a gain medium 7 positioned between the HRM 3 and output coupler 5. As such, the gain medium 7 is positioned within the laser cavity 9 formed by the HRM 3 and the output coupler 5. During use, an intra-cavity signal or beam 11 is generated in response to the gain medium 7 being seeded by the seed signal 13. The seed signal 13 is injected into the laser cavity and/or resonator 9 via the HRM 3, thereby providing an intra-cavity seed signal 15 which is incident upon the gain medium 7. At least a portion of the intra-cavity signal 11 may be outputted through the output coupler 5 to produce an output signal 17.

While the laser architecture described above has proven useful in the past, a number of shortcomings have been identified. For example, as shown in FIG. 1, the seed signal 13 is injected into the laser cavity 9 through a partially reflective HRM 3 (wherein the HRM 3 has a reflectivity of R<1). As such, at least a portion 19 of the seed signal 13 may be reflected/diffracted by the HRM 3 back to the seed source or neighboring devices (not shown), thereby reducing system performance and/or damaging sensitive components. In addition, a portion 21 of the intra-cavity signal 11 may be transmitted through the HRM 3, thereby potentially damaging neighboring components and/or devices. Further, these laser systems tend to suffer from high intra-cavity losses thereby reducing system efficiency and/or may require expensive and/or complex isolation systems and/or devices such as Faraday isolators and the like.

In response, various laser architectures have been developed which seek to reduce the likelihood of reflected/diffracted seed signals causing damage to sensitive components and/or subsystems. For example, FIG. 2 shows an embodiment of a laser system which incorporates a ring architecture. As shown, the laser system 31 includes at least one HRM 33, an output coupler 35, and at least one gain medium 37 positioned between at least one of the HRM 33 and the output coupler 35. A laser cavity or resonator 39 may be formed by at least one of the HRM 33 and the output coupler 35. The gain medium 37 may be positioned within the laser cavity 39. At least one intra-cavity signal 41 may be generated within the laser cavity 39 when the gain medium 37 is irradiated by a seed signal 43. In the illustrated embodiment, the seed signal 43 is injected into the laser cavity 39 via an acousto-optic modulator 45 coupled to a transducer 47. An intra-cavity seed signal 49 traverses through the laser cavity 39 and is incident on the gain medium 37, resulting in the generation of the intra-cavity signal 41. A portion of the intra-cavity signal 41 is outputted through the output coupler 35 to produce an output signal 51.

While the folded cavity architecture shown in FIG. 2 has proven useful, a number of shortcomings have been identified. For example, when the modulator 45 and transducer 47 are active a large fraction of the resonator light propagating along the resonator axis is deflected off the resonator axis thereby reducing the resonator quality. Further, pulsed seeding of the laser cavity 39 requires precise temporal control of the modulator 45 with transducer 47 which has proven difficult. In addition, some transmitted seed signal 53 may be incident upon devices and/or components positioned within the laser cavity 39 or devices positioned outside the laser cavity 39, thereby potentially damaging sensitive components and devices.

In light of the foregoing, there is an ongoing need for devices enabling novel injection seeding architectures for use with laser oscillators.

### SUMMARY

The present application is directed to various architectures of a laser oscillator which include a reflective, refractive, or diffractive injection device for injection seeding and/or locking a laser oscillator. In one embodiment, the present application discloses a laser oscillator, having a laser cavity formed by at least one high reflectance mirror and at least one output coupler. The laser cavity defines a resonator axis. At least one seed source may be configured to emit at least one seed signal to the laser cavity. Further, the laser oscillator may include at least one seed aperture device having at least one reflective area defining and at least one transmission area formed therein. In one embodiment, the seed aperture may be positioned within the laser cavity wherein the transmission area is positioned along the resonator axis of the laser cavity. The reflective area of the seed aperture device may be configured to reflect at least a portion of the seed signal to form at least one reflected seed signal. In addition, at least one gain medium may be positioned within the laser cavity along the resonator axis. The gain medium may be configured to be seeded by at least a portion of the seed signal and reflected seed signal and generate at least one intra-cavity signal in response thereto. The intra-cavity signal traverses collinear to the resonator axis of the laser cavity. At least a portion of the intra-cavity signal may be outputted via the output coupler to form an output signal.

In another embodiment, the present application is directed to a laser oscillator having a laser cavity formed by a high reflectance mirror and an output coupler, wherein the laser cavity defines a resonator axis. At least one seed source configured to emit at least one seed signal to the laser cavity is in optical communication with the laser cavity. Further, at least one seed aperture device having at least one reflective area and at least one transmission area formed therein may be positioned within the laser cavity. In one embodiment, the transmission area is positioned along the resonator axis of the laser cavity. The reflective area of the seed aperture device may be configured to reflect at least a portion of the seed signal to form at least one reflected seed signal. At least one gain medium may be positioned within the laser cavity along the resonator axis. The gain medium may be configured to be seeded by at least a portion of seed signal and the reflected seed signal and generate at least one intra-cavity signal in response thereto. The intra-cavity signal traverses collinear to the resonator axis of the laser cavity, wherein at least a portion of the intra-cavity signal may be outputted from the laser cavity by the output coupler to form at least one output signal.

In still another embodiment, the present application discloses a laser oscillator having a laser cavity formed by multiple high reflectance mirrors and an output coupler, wherein the laser cavity defines a resonator axis. At least one seed source configured to emit at least one seed signal to the laser cavity may be in optical communication with the laser cavity. Further, at least one seed aperture device having at least one reflective area and at least one transmission area formed therein may be included in the laser oscillator. In one embodiment, the seed aperture is positioned within the laser cavity wherein the transmission area is positioned along the resonator axis of the laser cavity. Further, the reflective area of the seed aperture device may be configured to reflect at least a portion of the seed signal to form at least one reflected seed signal. At least one gain medium may be positioned within the laser cavity along the resonator axis. The gain medium may be configured to be seeded by at least a portion of the seed signal and at least a portion of the reflected seed signal and generates at least one intra-cavity signal in response thereto. The intra-cavity signal traverses collinear to the resonator axis of the laser cavity, wherein at least a portion of the intra-cavity signal may be outputted from the laser cavity by the output coupler to form at least one output signal.

In addition, the present application discloses a laser oscillator having a laser cavity formed by at least one high reflectance mirror and at least one output coupler, wherein the laser cavity defines a resonator axis. At least one seed source may be configured to emit at least one seed signal to the laser cavity. The laser oscillator may include at least one seed aperture device having at least one diffractive area defining and at least one transmission area formed therein. The seed aperture may be positioned within the laser cavity wherein the transmission area is positioned along the resonator axis of the laser cavity. Further, the diffractive area of the seed aperture device may be configured to diffract at least a portion of the seed signal to form at least one diffracted seed signal. At least one gain medium may be positioned within the laser cavity along the resonator axis, the gain medium configured to be seeded by at least a portion of the seed signal and at least a portion of the diffracted seed signal and generate at least one intra-cavity signal in response thereto, wherein the intra-cavity signal traverses collinear to the resonator axis of the laser cavity. At least a portion of the intra-cavity signal may be outputted from the laser cavity by the output coupler to form at least one output signal.

Other features and advantages of the embodiments of the laser as disclosed herein will become apparent from a consideration of the following detailed description.

### BRIEF DESCRIPTION OF THE DRAWINGS

Various embodiments of a laser oscillator which include a novel injection element for injection seeding will be explained in greater detailing in the following description and shown in the accompanying drawings, wherein:

FIG. 1 shows a schematic diagram of an embodiment of a prior art laser oscillator;

FIG. 2 shows a schematic diagram of another embodiment of a prior art laser oscillator;

FIG. 3 shows a schematic diagram of an embodiment of a laser oscillator which includes a reflective seed aperture device therein;

FIG. 4 shows a schematic diagram of an embodiment of a laser oscillator which includes multiple highly reflective mirrors and a reflective seed aperture device therein;

FIG. 5 shows a schematic diagram of another embodiment of a laser oscillator which includes a reflective seed aperture device therein;

FIG. 6 shows a schematic diagram of another embodiment of a laser oscillator which includes a reflective seed aperture device therein;

FIG. 7 shows a schematic diagram of another embodiment of a laser oscillator which includes a reflective seed aperture device external of the laser cavity;

FIG. 8 shows a schematic diagram of another embodiment of a laser oscillator which includes a seed aperture device external of the laser cavity;

FIG. 9a shows an elevated perspective view of an embodiment of a reflective seed aperture device;

FIG. 9b shows an elevated perspective view of another embodiment of a reflective seed aperture device;

FIG. 9c shows an elevated perspective view of an embodiment of a refractive seed aperture device;

FIG. 9d shows an elevated perspective view of an embodiment of a diffractive seed aperture device;

FIG. 10a shows a representation of the intensity of the intra-cavity seed signal at point A (near field) as shown in FIGS. 3-8;

FIG. 10b shows a representation of the intensity of the intra-cavity seed signal at point B as shown in FIGS. 3-8; and

FIG. 10c shows a representation of the intensity profile of the intra-cavity seed signal at point C (far field) as shown in FIGS. 3-8.

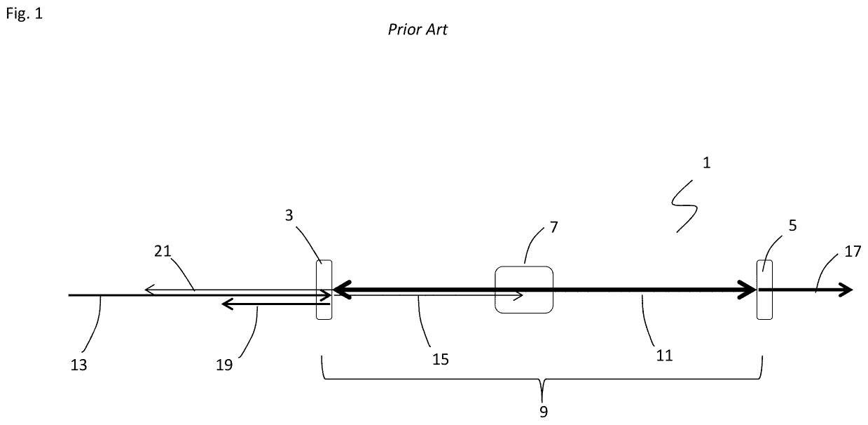

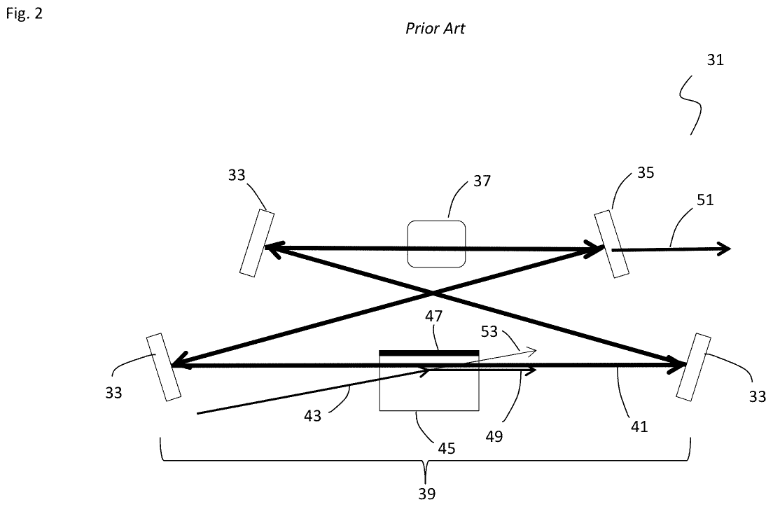

### DESCRIPTION

The present application is directed to various architectures of a laser oscillator which include an optical element, reflective, refractive, or diffractive injection device for injection seeding and/or seeding a laser oscillator. In some embodiments, a novel injection device is positioned within the laser resonator and/or laser cavity. In other embodiments, at least one novel injection device may be positioned outside the laser resonator and or laser cavity. Further, those skilled in the art will appreciate that the novel injection device and laser architectures disclosed herein may be used in any variety of laser amplifiers, laser oscillators, laser resonators, and the like. Moreover, the novel injection device may be used with any variety of seed sources, pump sources and the like.

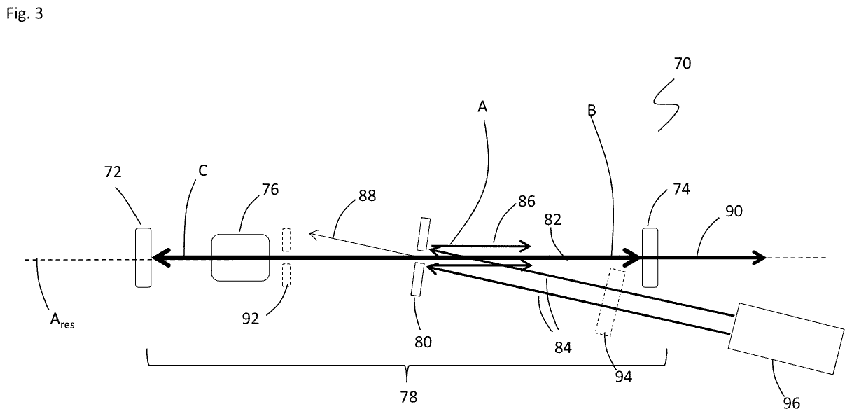

FIG. 3 shows an embodiment of a laser system or oscillator having at least one reflective seed aperture or similar device positioned therein. More specifically, the laser system 70 includes at least one high reflectance mirror 72 (hereinafter HRM 72), at least one output coupler 74, and at least one gain medium 76 positioned between the HRM 72 in the output coupler 74. In one embodiment, the gain medium 76 comprises Nd:YVO. In another embodiment, the gain medium 76 comprises Yb:YAG, Yb:glass, Yb:CaF₂, Yb:KGW, Yb:CALGO, Nd:YLF, Nd:YAG, and the like. Optionally, any variety of materials may be used to form the gain medium 76 including, without limitation, Nd:LuAG, Nd:YAlO₃, Nd:GdVO₄,Nd:LiLuF₄, Nd:GSGG, Ti:sapphire, Cr:LiCAF, Cr:LiSAF, Cr:LiSCAF, Cr:LiSGaF, Cr:GSGG. Further, multiple devices or materials may be used to form the gain medium 76.

Referring again to FIG. 3, in the illustrated embodiment the HRM 72 and output coupler 74 cooperatively form a laser resonator or cavity 78 (hereinafter laser resonator 78) configured to have at least one gain medium 76 positioned therein. At least one reflective seed aperture device 80 may be positioned within the laser resonator 78. As shown, at least one intra-cavity signal 82 may be generated within the resonator 78 when at least a portion of a seed signal 84 emitted from at least one seed source 96 is injected into the laser resonator 78 via the reflective seed aperture device 80 and is incident upon the gain medium 76 positioned within the laser resonator 78. In the present embodiment, and all the embodiments described in the present application, the seed signal 84 may comprise a collimated or slightly focused signal; although those skilled in the art will appreciate that the seed signal 84 need not be collimated nor focused. During use, the reflective seed aperture device 80 reflects at least a portion of the seed signal 84 to form at least one reflected seed signal 86 within the laser resonator 78. Further, in some embodiments, the reflective seed aperture 80 offers very low diffraction losses for the transverse laser mode (TEM₀₀) while reducing and/or eliminating reflection loses for the laser mode. Those skilled in the art will appreciate that the seed signal (e.g. seed signal 84) may comprises a continuous wave (cw) or pulsed signal in any of the various embodiments of the laser oscillator or resonators described in the present application. As such, any variety of seed sources 96 may be used with the present system. Further, in the illustrated embodiment, the seed source 96 is located external of the laser cavity 78, although those skilled in the art will appreciate that the seed source 96 need not be located externally. In one embodiment, the reflected seed signal 86 is co-aligned with the optical axis Aᵣₑₛ of the laser resonator 78. Further, the reflective seed aperture 80 is configured to seed the gain medium 76 without influencing the transversal resonator mode. Optionally, the reflected seed signal 86 need not be collinear to the optical axis Aᵣₑₛ of the laser resonator 78. In addition, a portion of the seed signal 84 may traverse through the reflective seed aperture device 80 and may be transmitted out of the laser resonator to form a transmitted seed signal 88. Optionally, a portion of the transmitted seed signal 88 may be reflected back into or otherwise re-injected into the laser resonator 78.

As shown in FIG. 3, the gain medium 76 generates at least one intra-resonator signal 82 in response to being seeded by the reflected seed signal 86 traversing through the laser resonator 78. At least a portion of the intra-cavity signal 82 is transmitted through the output coupler 74 to form at least one output signal or beam 90. Optionally, at least one additional optical component, device, and/or aperture 92 may be positioned anywhere within the laser resonator 78. For example, in one embodiment the additional optical component 92 comprises at least one mode aperture. In another embodiment, the additional optical component 92 comprises at least one acousto-optic modulator, electro-optic modulator, Q-switch, sensor, dispersion compensation system, pulse stretcher, compressor, and the like. Those skilled in the art will appreciate the any variety of additional optical components 92 may be positioned within the laser resonator 78. In some embodiments, an additional optical components or system may be used to condition the seed signal 84 prior to be directed into the resonator 78. For example, in one embodiment, at least one additional optical element 94 may be used to condition the seed signal 84. In one embodiment, the optical element 94 comprises a collimator. In another embodiment, the optical element 94 may comprise, without limitations, homogenizers, lenses, filters, wave plates, polarizers, and the like.

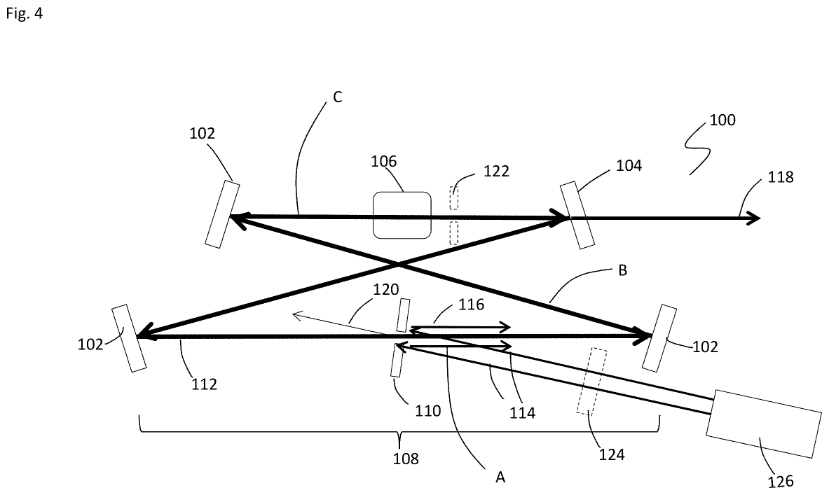

In contrast to the linear laser resonator shown in FIG. 3, FIG. 4 shows an embodiment of a laser system having at least one reflective aperture positioned within a ring laser resonator. As shown, the laser system 100 may include multiple high reflective mirrors 102 (hereinafter HRM 102). In the illustrated embodiment, the laser system 100 includes three (3) HRMs 102, although those skilled in the art will appreciate that any number of HRMs 102 may be used. At least one output coupler 104 is positioned within the laser system 100. At least one HRM 102 and the output coupler 104 may be configured to cooperatively form at least one resonator or cavity 108. At least one gain medium or similar gain device 106 may be positioned within the resonator 108.

Referring again to FIG. 4, one or more reflective seed apertures 110 may be positioned anywhere within the resonator 108. During use at least one seed signal 114 may be injected into the resonator 108 via the reflective seed aperture 110. At least a portion of the seed signal 114 may be configured to traverse through the resonator 108 via at least one HRM 102, the seed signal 114 emitted from at least one seed source 126 is configured to be incident upon the gain medium 106. At least one intra-cavity signal 112 may be generated by the gain medium 106 in response to being seeded by the seed signal 114. More specifically, at least a portion of the seed signal 114 is reflected by the reflective seed aperture 110 to form at least one intra-cavity seed signal 116, the intra-cavity seed signal 116 being reflected by at least one of the HRM 102 and/or the output coupler 104. During use, at least a portion of the intra-cavity signal 112 may be transmitted through the output coupler 104 to form at least one output signal 118. Further, in one embodiment at least a portion of the seed signal 114 may be transmitted through the reflective seed aperture 110 and transmitted from the resonator 108 to form at least one transmitted seed signal 120. As shown in FIG. 4, in the illustrated embodiment at least one optional optical element or device 122 may be positioned within the resonator 108. For example, in one embodiment the optional optical element 122 comprises a mode aperture, filter, sensor, lens, grating, mirror, or similar optical element or device may be positioned anywhere within the laser system 100. In some embodiments, an additional optical component or system may be used to condition the seed signal 114 prior to be directed into the resonator 108. For example, in one embodiment, at least one additional optical element 124 may be used to condition the seed signal 114. In one embodiment, the optical element 124 comprises a collimator. In another embodiment, the optical element 124 may comprise, without limitations, homogenizers, lenses, filters, wave plates, polarizers, and the like.

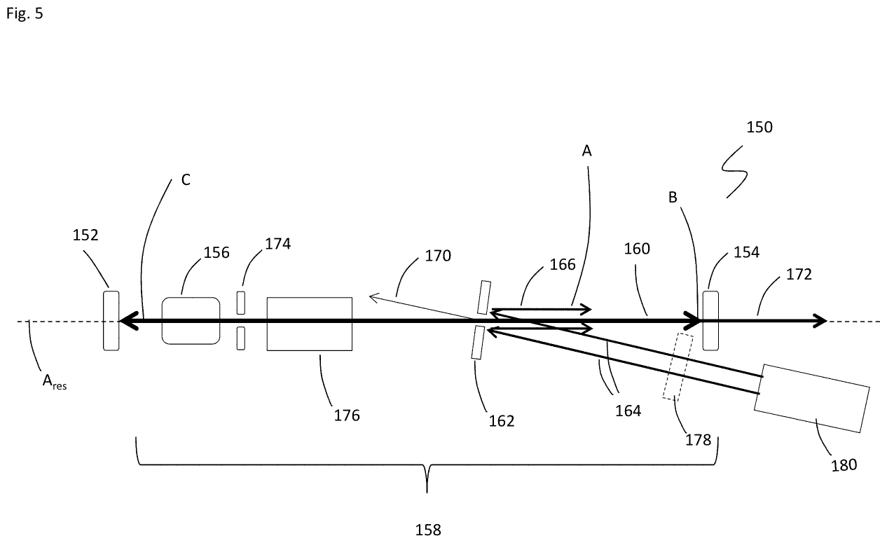

FIG. 5 shows another embodiment of a laser system having at least one reflective seed aperture or similar device positioned therein. Like the previous embodiments, the laser system 150 includes at least one high reflectance mirror 152 (hereinafter HRM 152), at least one output coupler 154, with at least one gain medium 156 positioned between the HRM 152 in the output coupler 154. Like the previous embodiments, any variety of materials may be used to form the gain medium 156.

Referring again to FIG. 5, in the illustrated embodiment the HRM 152 and output coupler 154 cooperatively form a laser resonator 158 configured to have at least one gain medium 156 positioned therein. At least one reflective seed aperture device 162 may be positioned within the laser resonator 158. As shown, at least one intra-cavity signal 160 may be generated within the resonator 158 when at least a portion of a seed signal 164 emitted from at least one seed source 180 is injected into the laser resonator 158 via the reflective seed aperture device 162 and is incident upon the gain medium 156 positioned within the laser resonator 158. Like the previous embodiments, during use, the reflective seed aperture device 162 reflects at least a portion of the seed signal 164 to form at least one reflected seed signal 166 within the laser resonator 158. In one embodiment, the reflected seed signal 166 is co-aligned with the optical axis Ares of the laser resonator 158. Optionally, the reflected seed signal 166 may or may not be collinear to the optical axis of the laser resonator 158. In addition, a portion of the seed signal 164 may traverse through the reflective seed aperture device 162 and may be transmitted out of the laser resonator to form at least one transmitted seed signal 170. Optionally, a portion of the transmitted seed signal 170 may be reflected back into or otherwise re-injected into the laser resonator 158.

As shown in FIG. 5, the gain medium 156 generates at least one intra-cavity signal 160 in response to being seeded by the reflected seed signal 166 traversing through the laser resonator 158. At least a portion of the intra-cavity signal 160 is transmitted through the output coupler 154 to form at least one output beam 172. Optionally, one or more optical components, devices, and/or apertures 174 may be positioned anywhere within the laser resonator 158. Exemplary additional optical component 174 include, without limitations, at least one mode aperture, sensor, dispersion compensation system, pulsed stretcher, compressor, and the like; although those skilled in the art will appreciate the any variety of additional optical components 174 may be positioned within the laser resonator 158. Further, as shown in FIG. 5, at least one modulator 176, such as an acousto-optical modulator, electro-optical modulator, mechanical modulator, Q-switch device and the like may be positioned within the laser resonator 158. In some embodiments, an additional optical component or system may be used to condition the seed signal 164 prior to be directed into the resonator 158. For example, in one embodiment, at least one additional optical element 178 may be used to condition the seed signal 164. In one embodiment, the optical element 178 comprises a collimator. In another embodiment, the optical element 178 may comprise, without limitations, homogenizers, lenses, filters, wave plates, polarizers, and the like.

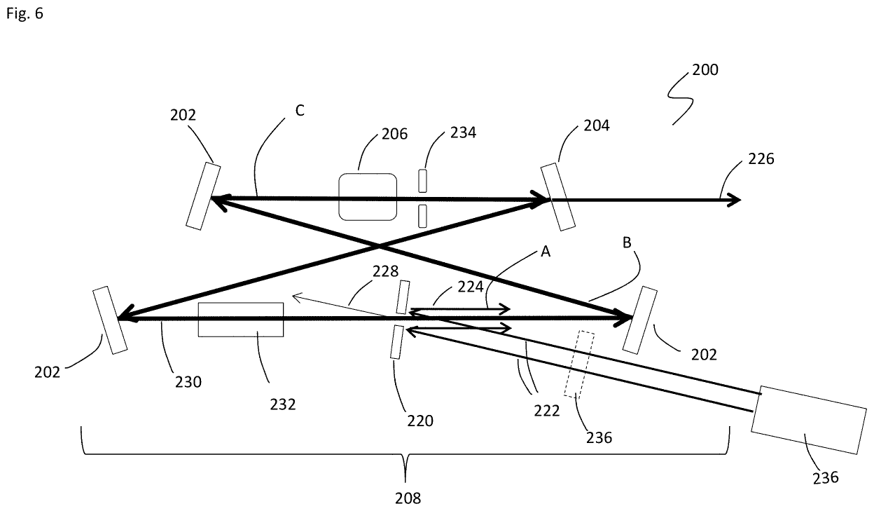

FIG. 6 shows an embodiment of a laser system having at least one reflective aperture positioned within a ring laser resonator. Like the embodiment shown in FIG. 4, the laser system 200 may include multiple high reflective mirrors 202 (hereinafter HRM 202). In the illustrated embodiment, the laser system 200 includes three (3) HRMs 202, although those skilled in the art will appreciate that any number of HRMs 202 may be used. At least one output coupler 204 is positioned within the laser system 200. At least one of the multiple HRMs 202 and the output coupler 204 may be configured to cooperatively form at least one resonator or resonator 208. At least one gain medium or similar gain device 206 may be positioned within the resonator 208.

Referring again to FIG. 6, one or more reflective seed apertures 220 may be positioned anywhere within the resonator 208. During use at least one seed signal 222 emitted from at least one seed source 236 is may be injected into the resonator 208 via the reflective seed aperture 220 to form at least one intra-cavity seed signal 224. At least a portion of the intra-cavity seed signal 224 may be configured to traverse through the resonator 208 and to be incident upon the gain medium 206, which may generate one or more intra-cavity signals 230. During use, at least a portion of the intra-cavity signal 230 may be transmitted through the output coupler 204 to form at least one output signal 226. Further, in one embodiment at least a portion of the seed signal 222 may be transmitted through the reflective seed aperture 220 and transmitted from the resonator 208 to form at least one transmitted seed signal 228. As shown in FIG. 6, in the illustrated embodiment at least one optional optical element or device 234 may be positioned within the resonator 208. For example, in one embodiment the optional optical element 234 comprises a mode aperture, filter, sensor, lens, grating, mirror, or similar optical element or device may be positioned anywhere within the laser system 200. Further, optionally, at least one modulator or similar device 232 may be positioned within the resonator 208. Exemplary modulators 232 include, without limitations, acousto-optical modulator, electro-optical modulator, mechanical modulator, Q-switch device and the like. In some embodiments, an additional optical component or system may be used to condition the seed signal 222 prior to be directed into the resonator 208. For example, in one embodiment, at least one additional optical element 235 may be used to condition the seed signal 222. In one embodiment, the optical element 235 comprises a collimator. In another embodiment, the optical element 235 may comprise, without limitations, homogenizers, lenses, filters, wave plates, polarizers, and the like.

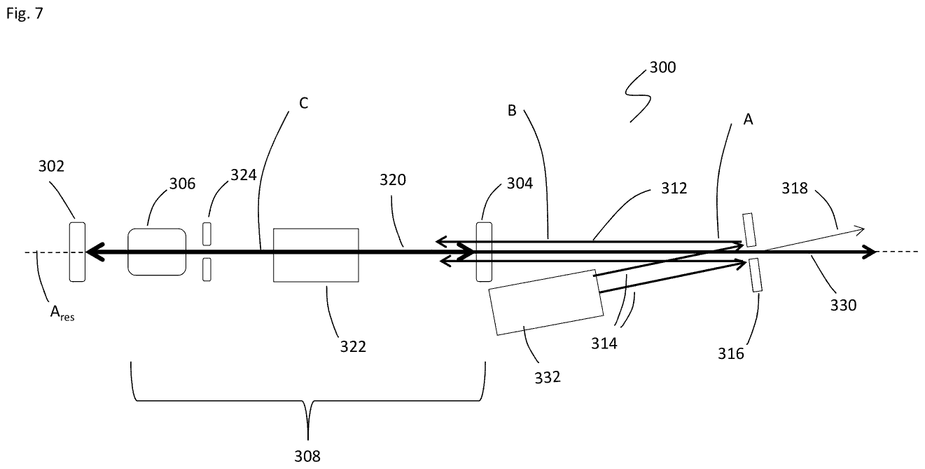

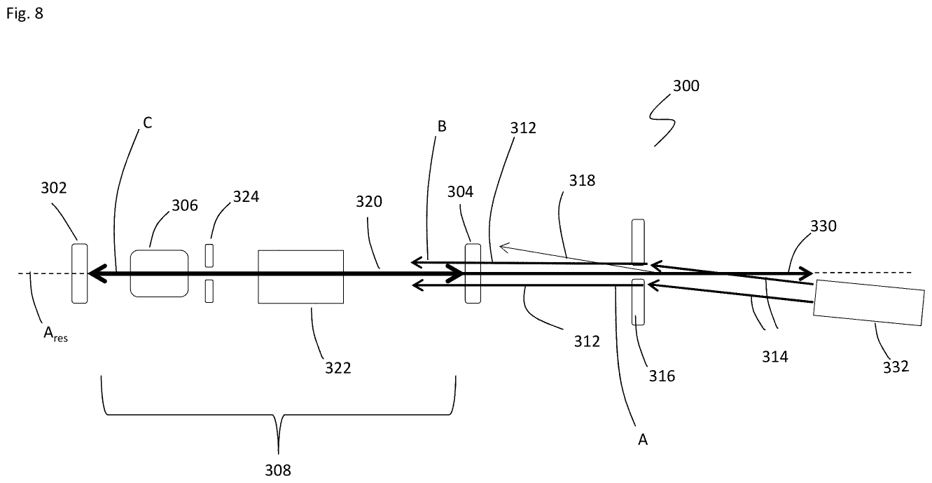

FIGS. 3-6 show various embodiments of a laser system having a reflective seed aperture device positioned within the laser resonator. Optionally, at least one seed aperture may be positioned outside the laser resonator. For example, FIGS. 7 and 8 show various embodiments of a laser system have at least one seed aperture device positioned external of the laser resonator. As shown in FIGS. 7 and 8, like the previous embodiments, the laser system 300 includes at least one high reflecting mirror or partially reflecting mirror (hereinafter PRM) 302 and at least one output coupler 304. The PRM 302 and output coupler 304 cooperatively form a laser resonator or cavity 308 (hereinafter laser resonator 308). At least one gain medium 306 may be positioned within the laser resonator 308.

Referring again to FIGS. 7 and 8, at least one injected seed signal 312 may be injected into the laser resonator 308 via at least one of the PRM 302 (R<1) and/or the output coupler 304. The injected seed signal 312 emitted from at least one seed source 332 may be formed by directing at least one seed signal 314 to at least one seed aperture device 316 positioned external of the laser resonator 308. FIG. 7 shows an embodiment wherein the seed signal 314 is reflected by a portion of the seed aperture device 316 and is injected into the laser resonator 308 substantially co-linear with the resonator axis Aᵣₑₛ of the laser resonator 308. In contrast, and unlike the previous embodiments, FIG. 8 shows an embodiment wherein the seed signal 314 traverses through a portion of a diffractive seed aperture device 316 and is diffracted by the seed aperture such that the injected seed signal 312 is substantially co-linear with the resonator axis Aᵣₑₛ of the laser resonator 308. As such, those skilled in the art will appreciate that the seed aperture device 316 may be reflective or diffractive. As shown in FIGS. 7 and 8, a portion of the seed signal 314 traversing through the seed aperture device 316 forms the injected seed signal 312 which is substantially co-linear with the resonator axis Aᵣₑₛ of the laser resonator 308. In addition, a portion of the seed signal 314 traversing through the seed aperture 316 may form at least one transmitted seed signal 318 which may be reflected into the laser resonator 308. The gain medium 306 positioned within the laser resonator 308 may generate at least one intra-cavity signal 320 a portion of which may be transmitted through the output coupler 304 to form at least one output signal 330. In the illustrated embodiment, the output signal 330 traverses through a portion of the seed aperture device 316 although those skilled in the art will appreciate that the output signal 330 traverse through or otherwise interact with any portion of the seed aperture device 316. Optionally, at least one additional optical element 324 and/or modulator/Q switch device 322 may be positioned within the proximate to the laser resonator 308. Like the previous embodiment, one or more additional optical elements (not shown) may be used to condition or otherwise modify the seed signal prior to injection into the resonator.

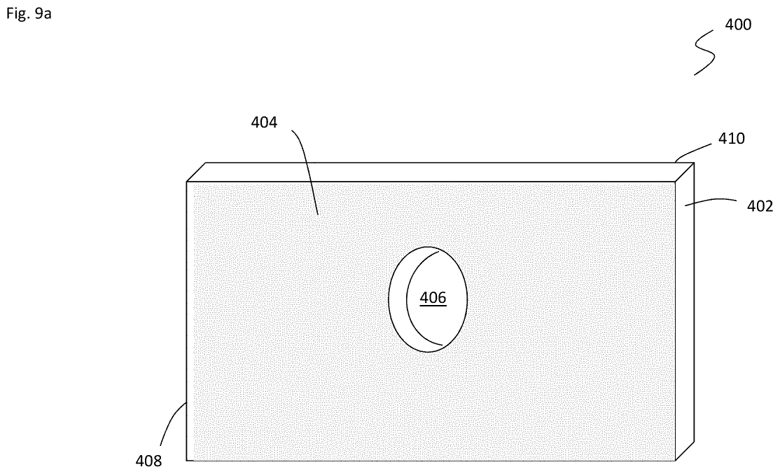

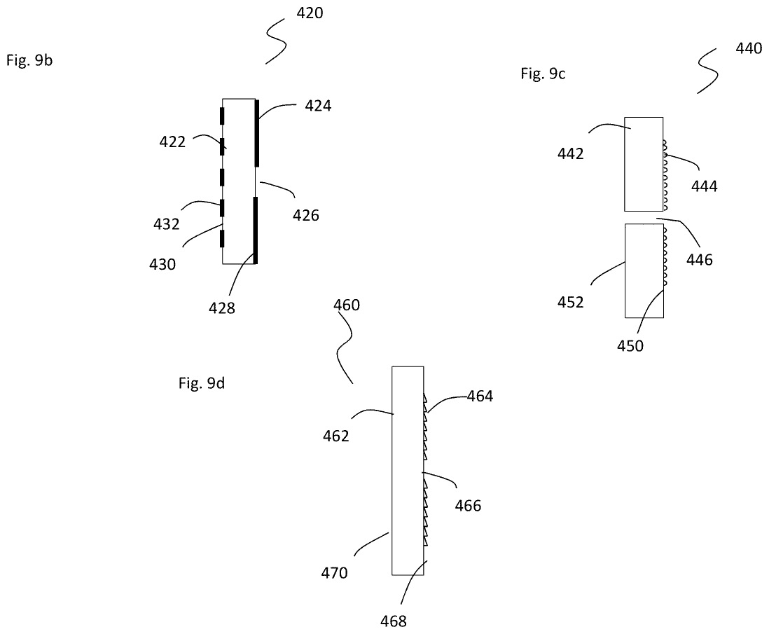

FIGS. 9a-9d show various embodiments of a reflective or refractive seed aperture device as used in the various embodiments of the laser systems and/or oscillators described above. As shown in FIG. 9a, the reflective seed aperture device 400 includes at least one substrate 402 having at least one reflective layer or material 404 deposited or otherwise formed on at least one surface of the substrate 402. In one embodiment, the substrate 402 may be manufactured from the silica-based material. Optionally, the substrate 402 may be manufactured from any variety of materials known in the art. Similarly, the reflective layer or material 404 may be manufactured from any variety of materials, including, without limitations, silver, gold, aluminum, thin-film materials, dielectric materials, and the like. Optionally, the reflective layer 404 may be configured to reflect a broad spectral range. In another embodiment, the reflective layer 404 is configured to reflect substantially all light within a defined first spectral range while transmitting light within a second spectral range. In the illustrated embodiment, the reflective layer 404 is formed on a first surface 408 of the substrate 402. Optionally, the reflective layer 404 may be formed on the second surface 410 of the substrate 402. In another embodiment, the reflective layer 404 may be formed on the first surface 408 and the second surface 410 of the substrate 402. Further, at least one aperture or transmission area those skilled in the art will appreciate that the aperture or transmission area 406 is configured to transmit substantially all light incident on the aperture or transmission area 406 of the reflective aperture device 400 there through. In one embodiment, the transmission area 406 comprises an uncoated portion of the substrate 402. In another embodiment, the transmission area 406 may include one or more coatings applied thereto. Exemplary coatings which may be applied to the transmission area 406 include, without limitations, anti-reflective coatings, polarizers, spatial filters, filters, and the like.

In contrast, FIG. 9b shows an alternate embodiment of a reflective aperture device for use with the laser systems and/or oscillators described above. As shown, the reflective aperture device 420 includes a substrate 422 having at least one reflective layer 424 apply to a first surface 428 of the substrate 422. Like the previous embodiment, at least one aperture or transmission area 426 is configured to transmit substantially all light incident thereon through the substrate 422 of the reflective aperture device 420. In one embodiment, the transmission area 426 comprises an uncoated portion of the substrate 422. In another embodiment, the transmission area 426 may include one or more coatings applied thereto. Exemplary coatings which may be applied to the transmission area 426 include, without limitations, anti-reflective coatings, polarizers, spatial filters, filters, and the like. Like the previous embodiment, the reflective layer 424 may be applied to the first surface 428, second surface 430, or both surfaces of the substrate 422. In the illustrated embodiment, the reflective layer 424 is applied to the first surface 428 of the substrate 422. Further, at least one optional feature or material 432 may be applied to the second surface 430 of the substrate 422. In one embodiment, the optional feature 432 comprises an additional reflective layer. For example, in one embodiment the reflective layer 424 may be configured to reflect light within a first spectral range, while the optional feature 432 is configured to reflect light within a second spectral range. In one embodiment the first spectral range and second spectral range are the same. In another embodiment the first spectral range and the second spectral range comprise different spectral ranges. In another embodiment, the optional feature 432 comprises one or more diffractive elements. In still another embodiment, the optional feature 432 comprises one or more optical filters, obscurations, sensors, wave plates, polarizers, and the like.

FIG. 9c shows an embodiment of a refractive aperture device we use the laser oscillators and resonators described above. As shown in FIG. 9c, the refractive seed aperture device 440 may include a substrate body 442 having one or more transmissive and or refractive elements or features 444 formed on or otherwise positioned on a first surface 450 of the substrate 442. In the illustrated embodiment, the second surface 452 of the substrate 442 does not include any coatings or features thereon. Optionally, one or more coatings, features, and the like may be selectively applied to at least a portion of the second surface 452 of the substrate 442. Like the previous embodiments, at least one transmission area 446 comprises a transmissive portion (i.e. non-refractive) of the substrate 442. In another embodiment, the transmission area 446 may include one or more coatings applied thereto. Exemplary coatings which may be applied to the transmission area 446 include, without limitations, anti-reflective coatings, polarizers, spatial filters, filters, and the like.

In contrast, FIG. 9d shows yet another embodiment of a diffractive aperture device for use with laser oscillators and resonators described above. As shown in FIG. 9d, the diffractive seed aperture device 460 may include a substrate 462. One or more reflective diffraction elements or features 464 may be formed or positioned on the first surface 468 of the substrate 462. In addition, like the previous embodiments, the second surface 470 of the substrate 462 may or may not include one or more coatings, diffractive elements, or optical features formed thereon. At least one transmission area 466 comprises a transmissive portion (i.e. non-diffractive) of the substrate 462. In another embodiment, the transmission area 466 may include one or more coatings applied thereto. Exemplary coatings which may be applied to the transmission area 466 include, without limitations, anti-reflective coatings, polarizers, spatial filters, filters, and the like.

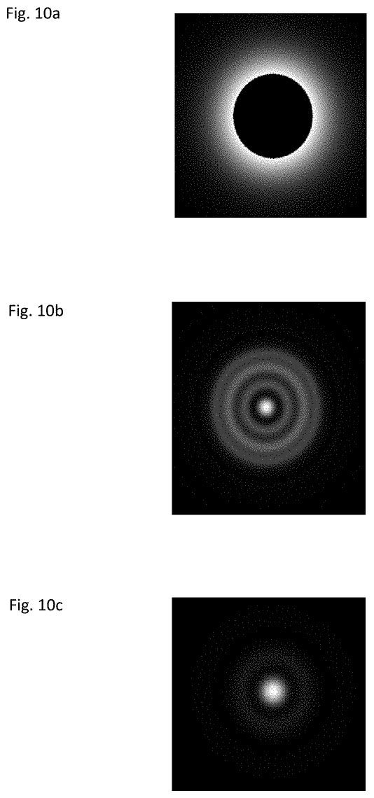

FIGS. 10a-10c show various views of the intensity profiles of the seed signal at various points within the laser devices shown in FIGS. 3-8. As shown, FIG. 10a shows the intensity profile of the intra-cavity seed signal after engaging the seed aperture. For example, FIG. 10a shows the intensity of the intra-cavity seed signal at point A (near field) as shown in FIGS. 3-8. In contrast, FIG. 10b shows the intensity of the intra-cavity seed signal at point B as shown in FIGS. 3-8. FIG. 10c shows the intensity profile of the intra-cavity seed signal at point C (far field) as shown in FIGS. 3-8. Those skilled in the art will appreciate that seeding a laser oscillator or resonator via the various seeding apertures described herein improved in-coupling efficiency along the resonator axis over prior art architectures. In one embodiment, the in-coupling efficiency is improved by about 30% as compared with prior art architectures. In another embodiment, the in-coupling efficiency is improved by about 40% as compared with prior art architectures. Other embodiments, the in-coupling efficiency is improved by about 50% as compared with some prior art architectures. Further, the various embodiments of the laser oscillators described herein which incorporate a seed aperture device offer greatly reduced back reflectance of the seed signal and the intra-cavity laser signal to the seeding device or seeding laser.

The embodiments disclosed herein are illustrative of the principles of the invention. Other modifications may be employed which are within the scope of the invention. Accordingly, the devices disclosed in the present application are not limited to that precisely as shown and described herein.

What is claimed:

1. A laser oscillator, comprising:
a laser cavity formed by at least one high reflectance mirror and at least one output coupler, the laser cavity defining a resonator axis;
at least one seed source configured to emit at least one seed signal to the laser cavity;
at least one seed aperture device having at least one reflective area and at least one transmission area formed therein, the at least one seed aperture positioned within the laser cavity wherein the at least one transmission area is positioned along the resonator axis of the laser cavity, the at least one reflective area of the at least one seed aperture device configured to reflect at least a portion of the at least one seed signal to form at least one reflected seed signal; and
at least one gain medium positioned within the laser cavity along the resonator axis, the at least one gain medium configured to be seeded by at least a portion of at least one seed signal and at least a portion of the at least one reflected seed signal and generate at least one intra-cavity signal in response thereto, the at least one intra-cavity signal traversing collinear to the resonator axis of the laser cavity, wherein at least a portion of the intra-cavity signal may be outputted from the laser cavity by the output coupler to form at least one output signal.

2. The laser oscillator of claim 1 wherein the laser cavity is formed from one high reflectance mirror and one output coupler.

3. The laser oscillator of claim 1 wherein the laser cavity is formed from multiple high reflectance mirrors and one output coupler.

4. The laser oscillator of claim 1 wherein the at least one seed signal comprises a pulsed signal.

5. The laser oscillator of claim 1 wherein the at least one seed signal comprises a continuous wave signal.

6. The laser oscillator of claim 1 wherein the at least one gain medium comprises Nd:YVO.

7. The laser oscillator of claim 1 wherein the at least one gain medium comprises at least one material selected from the group consisting of Yb:YAG, Yb:glass, Yb:CaF₂, Yb:KGW, Yb:CALGO, Nd:YLF, Nd:YAG, Nd:LuAG, Nd:YAlO₃, Nd:GdVO₄, Nd:LiLuF₄, Nd:GSGG, Ti:sapphire, Cr:LiCAF, Cr:LiSAF, Cr:LiSCAF, Cr:LiSGaF, and Cr:GSGG.

8. The laser oscillator of claim 1 further comprising at least one optical element positioned within the laser resonator.

9. The laser oscillator of claim 8 wherein the at least one optical element comprises at least one of a modulator and a transducer.

10. The laser oscillator of claim 8 wherein the at least one optical element is selected from the group consisting of mode apertures, sensors, dispersion compensation systems, pulsed stretchers, compressors, acousto-optical modulators, electro-optical modulators, mechanical modulators, Q-switch devices, collimators, homogenizers, lenses, filters, wave plates, and polarizers.

11. A laser oscillator, comprising:
a laser cavity formed by a high reflectance mirror and an output coupler, the laser cavity defining a resonator axis;
at least one seed source configured to emit at least one seed signal to the laser cavity;
at least one seed aperture device having at least one reflective area and at least one transmission area formed therein, the at least one seed aperture positioned within the laser cavity wherein the at least one transmission area is positioned along the resonator axis of the laser cavity, the at least one reflective area of the at least one seed aperture device configured to reflect at least a portion of the at least one seed signal to form at least one reflected seed signal; and
at least one gain medium positioned within the laser cavity along the resonator axis, the at least one gain medium configured to be seeded by at least a portion of at least one seed signal and at least a portion of the at least one reflected seed signal and generate at least one intra-cavity signal in response thereto, the at least one intra-cavity signal traversing collinear to the resonator axis of the laser cavity, wherein at least a portion of the intra-cavity signal may be outputted from the laser cavity by the output coupler to form at least one output signal.

12. The laser oscillator of claim 11 wherein the at least one seed signal comprises a pulsed signal.

13. The laser oscillator of claim 11 wherein the at least one gain medium comprises Nd:YVO.

14. The laser oscillator of claim 11 wherein the at least one gain medium comprises at least one material selected from the group consisting of Yb:YAG, Yb:glass, Yb:CaF₂, Yb:KGW, Yb:CALGO, Nd:YLF, Nd:YAG, Nd:LuAG, Nd:YAlO₃, Nd:GdVO₄, Nd:LiLuF₄, Nd:GSGG, Ti:sapphire, Cr:LiCAF, Cr:LiSAF, Cr:LiSCAF, Cr:LiSGaF, and Cr:GSGG.

15. The laser oscillator of claim 11 further comprising at least one optical element positioned within the laser resonator.

16. The laser oscillator of claim 15 wherein the at least one optical element comprises at least one of a modulator and a transducer.

17. The laser oscillator of claim 15 wherein the at least one optical element is selected from the group consisting of mode apertures, sensors, dispersion compensation systems, pulsed stretchers, compressors, acousto-optical modulators, electro-optical modulators, mechanical modulators, Q-switch devices, collimators, homogenizers, lenses, filters, wave plates, and polarizers.

18. A laser oscillator, comprising:
a laser cavity formed by multiple high reflectance mirrors and an output coupler, the laser cavity defining a resonator axis;
at least one seed source configured to emit at least one seed signal to the laser cavity;
at least one seed aperture device having at least one reflective area and at least one transmission area formed therein, the at least one seed aperture positioned within the laser cavity wherein the at least one transmission area is positioned along the resonator axis of the laser cavity, the at least one reflective area of the at least one seed aperture device configured to reflect at least a portion of the at least one seed signal to form at least one reflected seed signal; and
at least one gain medium positioned within the laser cavity along the resonator axis, the at least one gain medium configured to be seeded by at least a portion of at least one seed signal and at least a portion of the at least one reflected seed signal and generate at least one intra-cavity signal in response thereto, the at least one intra-cavity signal traversing collinear to the resonator axis of the laser cavity, wherein at least a portion of the intra-cavity signal may be outputted from the laser cavity by the output coupler to form at least one output signal.

19. The laser oscillator of claim 18 wherein the at least one seed signal comprises a pulsed signal.

20. The laser oscillator of claim 18 wherein the at least one gain medium comprises Nd:YVO.

21. The laser oscillator of claim 18 wherein the at least one gain medium comprises at least one material selected from the group consisting of Yb:YAG, Yb:glass, Yb:CaF₂, Yb:KGW, Yb:CALGO, Nd:YLF, Nd:YAG, Nd:LuAG, Nd:YAlO₃, Nd:GdVO₄, Nd:LiLuF₄, Nd:GSGG, Ti:sapphire, Cr:LiCAF, Cr:LiSAF, Cr:LiSCAF, Cr:LiSGaF, and Cr:GSGG.

22. The laser oscillator of claim 18 further comprising at least one optical element positioned within the laser resonator.

23. The laser oscillator of claim 22 wherein the at least one optical element comprises at least one of a modulator and a transducer.

24. The laser oscillator of claim 22 wherein the at least one optical element is selected from the group consisting of mode apertures, sensors, dispersion compensation systems, pulsed stretchers, compressors, acousto-optical modulators, electro-optical modulators, mechanical modulators, Q-switch devices, collimators, homogenizers, lenses, filters, wave plates, and polarizers.

25. A laser oscillator, comprising:
a laser cavity formed by at least one high reflectance mirror and at least one output coupler, the laser cavity defining a resonator axis;
at least one seed source configured to emit at least one seed signal to the laser cavity;
at least one seed aperture device having at least one diffractive area defining and at least one transmission area formed therein, the at least one seed aperture positioned within the laser cavity wherein the at least one transmission area is positioned along the resonator axis of the laser cavity, the at least one diffractive area of the at least one seed aperture device configured to diffract at least a portion of the at least one seed signal to form at least one diffracted seed signal; and
at least one gain medium positioned within the laser cavity along the resonator axis, the at least one gain medium configured to be seeded by at least a portion of at least one seed signal and at least a portion of the at least one diffracted seed signal and generate at least one intra-cavity signal in response thereto, the at least one intra-cavity signal traversing collinear to the resonator axis of the laser cavity, wherein at least a portion of the intra-cavity signal may be outputted from the laser cavity by the output coupler to form at least one output signal.

26. The laser oscillator of claim 25 wherein the at least one seed signal comprises a pulsed signal.

27. The laser oscillator of claim 25 wherein the at least one gain medium comprises Nd:YVO.

28. The laser oscillator of claim 25 wherein the at least one gain medium comprises at least one material selected from the group consisting of Yb:YAG, Yb:glass, Yb:CaF₂, Yb:KGW, Yb:CALGO, Nd:YLF, Nd:YAG, Nd:LuAG, Nd:YAlO₃, Nd:GdVO₄, Nd:LiLuF₄, Nd:GSGG, Ti:sapphire, Cr:LiCAF, Cr:LiSAF, Cr:LiSCAF, Cr:LiSGaF, and Cr:GSGG.

29. The laser oscillator of claim 25 further comprising at least one optical element positioned within the laser resonator.

30. The laser oscillator of claim 29 wherein the at least one optical element comprises at least one of a modulator and a transducer.

31. The laser oscillator of claim 29 wherein the at least one optical element is selected from the group consisting of mode apertures, sensors, dispersion compensation systems, pulsed stretchers, compressors, acousto-optical modulators, electro-optical modulators, mechanical modulators, Q-switch devices, collimators, homogenizers, lenses, filters, wave plates, and polarizers.
